(19) United States
(12) Patent Application Publication
(10) Pub. No.: US 2024/0420605 A1
(43) Pub. Date: Dec. 19, 2024

(54) DISPLAY DEVICE

(71) Applicant: ALPS ALPINE CO., LTD., Tokyo (JP)

(72) Inventor: Takashi YASUMOTO, Fukushima (JP)

(21) Appl. No.: 18/817,529

(22) Filed: Aug. 28, 2024

Related U.S. Application Data
(63) Continuation of application No. PCT/JP2023/005041, filed on Feb. 14, 2023.

(30) Foreign Application Priority Data
Mar. 3, 2022 (JP) 2022-032836

(51) Int. Cl. G09F 13/22

(52) U.S. Cl. CPC G09F 13/22; G09F 2013/222

(57) ABSTRACT

A display device includes a first decorative layer representing a decorative pattern; a light transmitting region provided in the first decorative layer, the light transmitting region being configured to transmit light; a scattering layer disposed below the first decorative layer, the scattering layer being configured to scatter the light; a light source disposed at a side of the scattering layer, the light source being configured to emit light toward the scattering layer; and a second decorative layer disposed below the scattering layer and at a position overlapping the light transmitting region, the second decorative layer representing a decorative pattern.

### CROSS-REFERENCE TO RELATED APPLICATIONS

This application is a continuation application of International Application No. PCT/JP2023/005041, filed on Feb. 14, 2023, and designated the U.S., which is based upon and claims priority to Japanese Patent Application No. 2022-032836, filed on Mar. 3, 2022, the entire contents of which are incorporated herein by reference.

### BACKGROUND

### 1. Field of the Invention

The present disclosure relates to a display device.

### 2. Description of the Related Art

Conventionally, a technique is used, in which a three dimension overlay method (TOM) formation is used to attach decorative sheets to surfaces of decoration target parts having three-dimensional shapes in various components (e.g., an inner panel) of a vehicle such that various decorative patterns decorate the surfaces of the decoration target parts (e.g., a metal pattern, a wood grain pattern, and the like) while protecting the surfaces of the decoration target parts.

With respect to such a decorative sheet, a technique is disclosed in Japanese Unexamined Patent Application Publication No. 2021-11114 in which light emitted from a light source disposed on the back side of the decorative sheet is transmitted through a light transmitting region having a predetermined design shape formed on a light shield layer, thereby displaying an optical image having the predetermined design shape on the surface of the decorative sheet.

### SUMMARY

According to an embodiment of the present disclosure, a display device is provided. The display device includes:
a first decorative layer representing a decorative pattern;
a light transmitting region provided in the first decorative layer, the light transmitting region being configured to transmit light;
a scattering layer disposed below the first decorative layer, the scattering layer being configured to scatter the light;
a light source disposed at a side of the scattering layer, the light source being configured to emit light toward the scattering layer; and
a second decorative layer disposed below the scattering layer and at a position overlapping the light transmitting region, the second decorative layer representing the decorative pattern.

### BRIEF DESCRIPTION OF THE DRAWINGS

FIG. 1 is an exploded perspective view of a display device according to an embodiment.

FIG. 2 is a view schematically illustrating a laminated structure of the display device according to the embodiment.

FIG. 3 is a view schematically illustrating a laminated structure of a display device according to a modification of the embodiment.

FIG. 4 is a view schematically illustrating a laminated structure of a display device according to a modification of the embodiment.

### DETAILED DESCRIPTION OF THE PRESENT DISCLOSURE

In the related art decorative sheet having such a configuration, since the optical image is displayed on the surface of the decorative sheet by the light transmitted through the decorative layer, the luminance of the optical image is attenuated by the decorative layer. In contrast, when the transparency of the decorative layer is increased, the outline of the light transmitting region is easily visible when the light source is turned off.

In the display device according to the embodiment, the luminance of an optical image can be increased when the light source is turned on, and the outline of the light transmitting region can be made less likely to be visible when the light source is turned off.

Hereinafter, an embodiment will be described with reference to the drawings.

### (Configuration of Display Device 10)

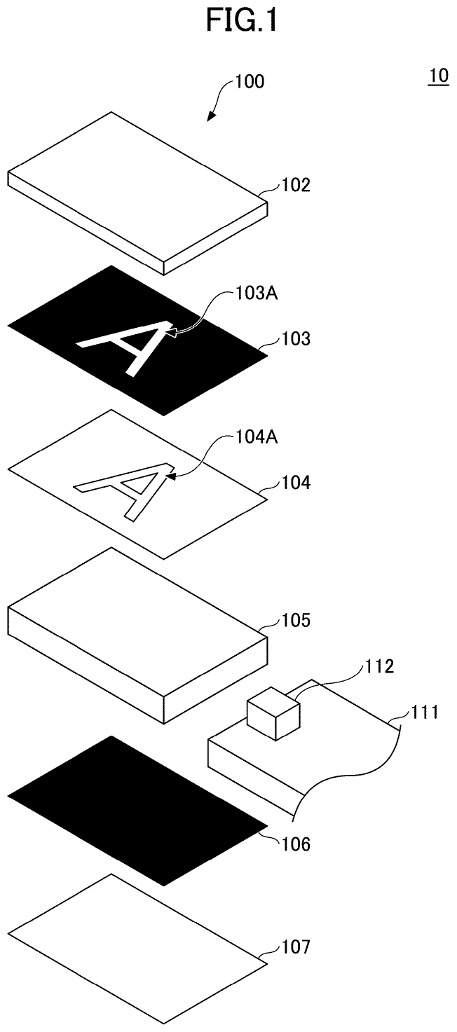

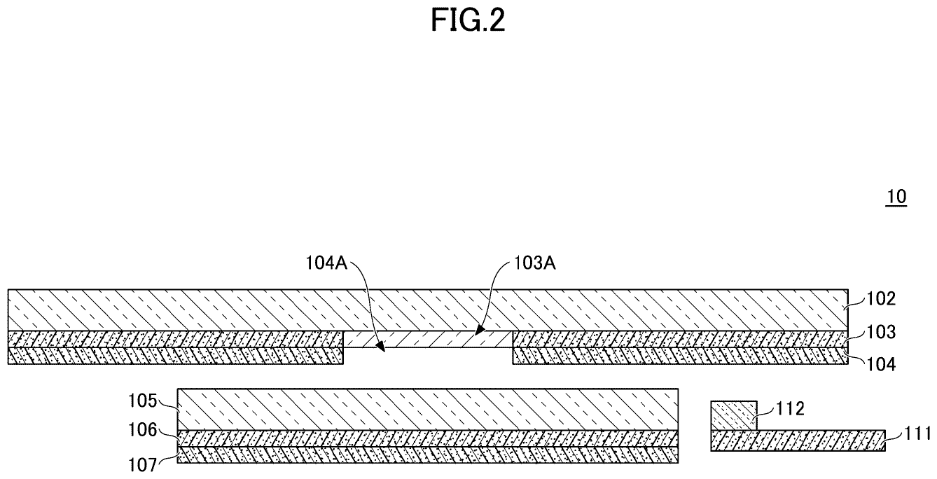

FIG. 1 is an exploded perspective view of a display device 10 according to an embodiment. FIG. 2 is a view schematically illustrating a laminated structure of the display device 10 according to the embodiment.

As illustrated in FIGS. 1 and 2, the display device 10 includes a display panel 100, a substrate 111, and a light emitting diode (LED) 112.

The display panel 100 is a sheet-like or plate-like material having a decorative pattern (e.g., a wood grain pattern, a metal pattern, a leather pattern, or the like) on a surface of the display panel 100. The display panel 100 is provided on a surface of any decoration target part (e.g., an interior panel of an automobile) to decorate the surface of the decoration target part.

As illustrated in FIGS. 1 and 2, the display panel 100 includes a base layer 102, a first decorative layer 103, a first color-tone adjusting layer 104, a scattering layer 105, a second decorative layer 106, and a second color-tone adjusting layer 107 in this order from a surface side of the display panel 100 (an upper side in the drawings).

The base layer 102 is a layer formed using a base material that serves as a base of the display panel 100. That is, the display panel 100 is formed by stacking other layers on the base layer 102. For example, the base layer 102 is formed using a transparent sheet-like or plate-like base material having flexibility (e.g., PMMA (Poly Methyl Methacrylate), PC (Polycarbonate), urethane, ABS (Acrylonitrile Butadiene Styrene), glass, or the like).

The first decorative layer 103 represents a decorative pattern (e.g., a wood grain pattern, a metal pattern, or the like) presented by the display panel 100. In the example illustrated in FIG. 2, the first decorative layer 103 is formed on a back surface of the base layer 102 (a surface on a lower side in the drawings). For example, the first decorative layer 103 is formed by printing a plurality of color inks (e.g., CMYK) on the back surface of the base layer 102 on a pixel-by-pixel basis in accordance with the pattern presented by the display panel 100.

The first decorative layer 103 partially transmits the light emitted from an LED 112, thereby displaying an optical image of a predetermined design shape (e.g., a character, a symbol, a figure, or the like) on the surface of the display panel 100. Therefore, the first decorative layer 103 is provided with a light transmitting region 103A having an opening shape that is the same shape as the optical image. For example, the light transmitting region 103A is formed by printing a translucent ink in the predetermined design shape on the back surface of the base layer 102.

The first color-tone adjusting layer 104 is formed on a back surface (a surface on the lower side in the drawings) of the first decorative layer 103. For example, the first color-tone adjusting layer 104 is printed on the first decorative layer 103 in an overlapping manner, thereby preventing leakage of light from a pinhole or the like of the first decorative layer 103. For example, the first color-tone adjusting layer 104 is formed in a single color and is printed on the first decorative layer 103 in an overlapping manner, thereby adjusting the overall brightness, hue, and saturation of the first decorative layer 103. In the first color-tone adjusting layer 104, a light transmitting region 104A having the same opening shape as the light transmitting region 103A is formed in a manner overlapping the light transmitting region 103A so that the light emitted from the LED 112 can be transmitted through the light transmitting region 103A. In this embodiment, the first decorative layer 103 and the first color-tone adjusting layer 104 are formed on the base layer 102 by printing such that the base layer 102, the first decorative layer 103, and the first color-tone adjusting layer 104 are integrally formed.

The scattering layer 105 is disposed at a distance below the first color-tone adjusting layer 104 and at a position overlapping the light transmitting region 103A in a plan view from above. The scattering layer 105 scatters light emitted from the LED 112 to cause the surface of the scattering layer 105 to emit light uniformly. This allows the scattering layer 105 to transmit light through the light transmitting region 103A so that the optical image displayed on the surface of the display panel 100 is uniformly emitted.

The scattering layer 105 is formed in a plate-like shape by incorporating scattering fine particles such as silica having light scattering properties into a transparent resin material such as an acrylic resin, such as PMMA (Poly Methyl Methacrylate) or PC (Polycarbonate). Thus, the scattering layer 105 is highly transparent when no light is incident from the LED 112, and can uniformly scatter light when light is incident from the LED 112. Note that the scattering layer 105 is not limited to a plate-like shape and can have a desired shape.

The particle diameter of the scattering fine particles contained in the scattering layer 105 is preferably 1 μm (micrometer) or less. With this range, it is possible to make the scattering fine particles contained in the scattering layer 105 substantially invisible from the surface side of the display panel 100.

The scattering layer 105 preferably has a haze of 4% or less. With this range, it is possible to obtain high transparency of the scattering layer 105 and to enhance visibility of the second decorative layer 106 through the scattering layer 105 from the surface side of the display panel 100.

The second decorative layer 106 is disposed below the scattering layer 105. The second decorative layer 106 is a layer that has the same decorative pattern as the first decorative layer 103 in which a light transmitting region 103A is not formed. For example, the second decorative layer 106 is formed by printing a plurality of color inks (e.g., CMYK) on a back surface of the scattering layer 105 on a pixel-by-pixel basis by thermal transfer printing using a thermal transfer printer.

The decorative pattern represented by the second decorative layer 106 has the same hue and saturation as the decorative pattern represented by the first decorative layer 103, and has a different brightness from the decorative pattern represented by the first decorative layer 103.

For example, when the decorative pattern represented by the first decorative layer 103 is a bright color (e.g., brightness L1>50), the brightness L2 of the decorative pattern represented by the second decorative layer 106 is set to be higher than the brightness L1 of the decorative pattern represented by the first decorative layer 103.

For example, when the decorative pattern represented by the first decorative layer 103 is a dark color (e.g., brightness L1<50), the brightness L2 of the decorative pattern represented by the second decorative layer 106 is set to be lower than the brightness L1 of the decorative pattern represented by the first decorative layer 103.

The second color-tone adjusting layer 107 is formed on a back surface (a surface on the lower side in the drawings) of the second decorative layer 106. For example, the second color-tone adjusting layer 107 is printed on the second decorative layer 106 in an overlapping manner, thereby preventing leakage of light from a pinhole or the like of the second decorative layer 106. For example, the second color-tone adjusting layer 107 is formed in a single color and is printed on the second decorative layer 106 in an overlapping manner, thereby adjusting the overall brightness, hue, and saturation of the second decorative layer 106. As in the relationship between the first decorative layer 103 and the second decorative layer 106 described above, the brightness of the second color-tone adjusting layer 107 is set to be higher than the brightness of the first color-tone adjusting layer 104 when the first color-tone adjusting layer 104 is a bright color, and the brightness of the second color-tone adjusting layer 107 is set to be lower than the brightness of the first color-tone adjusting layer 104 when the first color-tone adjusting layer 104 is a dark color.

In this way, the second color-tone adjusting layer 107 and the second decorative layer 106 are formed to be visible as a decorative surface that is substantially indistinguishable from a decorative surface provided by the first color-tone adjusting layer 104 and the first decorative layer 103 for a person who views the display device 10 from above when the LED 112 is turned off.

Note that in the present embodiment, the brightness of the first decorative layer 103 differs from the brightness of the second decorative layer 106. However, the brightness of the first decorative layer 103 may not necessarily differ from the brightness of the second decorative layer 106 insofar as the decorative surface provided by the first color-tone adjusting layer 104 and the first decorative layer 103 and the decorative surface provided by the second color-tone adjusting layer 107 and the second decorative layer 106 can be visible as substantially indistinguishable decorative surfaces for a person who views the display device 10 from above when the LED 112 is turned off.

In addition, in the present embodiment, the first decorative layer 103 and the second decorative layer 106 have the same hue and saturation, but the hue and saturation may be adjusted as required such that the decorative surface provided by the first color-tone adjusting layer 104 and the first decorative layer 103 and the decorative surface provided by the second color-tone adjusting layer 107 and the second decorative layer 106 can be visible as substantially indistinguishable decorative surfaces in viewing from above the display device 10 when the LED 112 is off.

In the present embodiment, the second decorative layer 106 and the second color-tone adjusting layer 107 are formed integrally with the scattering layer 105 by printing, which are disposed at a distance below the integrally formed base layer 102, first decorative layer 103, and first color-tone adjusting layer 104. However, the integrally formed second decorative layer 106, the second color-tone adjusting layer 107, and the scattering layer 105 may not be at a distance from and may be integrally formed with the top three layers of FIG. 2.

In addition, in the present embodiment, the first color-tone adjusting layer 104 and the second color-tone adjusting layer 107 are provided, but the first color-tone adjusting layer 104 and the second color-tone adjusting layer 107 may not necessarily be provided. The first decorative layer 103 or the second decorative layer 106 is not necessarily formed of one layer, and may be formed of multiple layers. In the case where the first decorative layer 103 or the second decorative layer 106 is formed of multiple layers, the first decorative layer 103 or the second decorative layer 106 may include a color-tone adjusting layer.

The substrate 111 and the LED 112 are disposed at a side of the scattering layer 105. The substrate 111 is a flat plate-like material. As the substrate 111, for example, a printed wired board (PWB), a flexible printed circuit (FPC), or the like can be used. The LED 112 is an example of a “light source” and is mounted on an upper surface of the substrate 111. The LED 112 emits light toward a side surface of the scattering layer 105 at a predetermined timing. The light emission timing of the LED 112 is controlled from outside.

### (Operation and Effects of Display Device 10)

The display device 10 according to the embodiment having the above-described configuration can cause the LED 112 to emit light to the side surface of the scattering layer 105 such that the light emitted from the LED 112 can be incident on the scattering layer 105 from the side surface of the scattering layer 105. Thus, the display device 10 according to the embodiment can scatter light incident on the scattering layer 105 and transmit the light through the light transmitting region 103A having a predetermined design shape. This enables the display device 10 to display an optical image having the predetermined design shape on the surface of the display panel 100.

Note that, in the display device 10 according to the embodiment, when the LED 112 is not emitting light, the optical image is not displayed on a surface of a decoration target part 110 (not illustrated), and only a decorative pattern can be visible.

In particular, the display device 10 according to the embodiment includes: a first decorative layer 103 representing a decorative pattern; a light transmitting region 103A provided in the first decorative layer 103 and configured to transmit light; a scattering layer 105 disposed below the first decorative layer 103 and configured to scatter light; a LED 112 disposed at a side of the scattering layer 105 and configured to emit light toward the scattering layer 105; and a second decorative layer 106 disposed below the scattering layer 105 and at a position overlapping the light transmitting region 103A, and the second decorative layer 106 representing the decorative pattern.

Thus, in the display device 10 according to the embodiment, when the LED 112 is turned on, the light that enters the scattering layer 105 from the side of the scattering layer 105 and is transmitted through the light transmitting region 103A is not attenuated by the first decorative layer 103. Thus, the luminance of the optical image displayed on the display panel 100 when the LED 112 is turned on can be increased.

In addition, in the display device 10 according to the embodiment, when the LED 112 is turned off, the LED and the like are not visible from the light transmitting region 103A, and the decorative pattern of the second decorative layer 106 is visible. This allows the display device 10 according to the embodiment to make the outline of the light transmitting region 103A difficult to be visible, because when the LED 112 is turned off, the LED, and the like are not visible from the light transmitting region 103A, but the decorative pattern of the second decorative layer 106 is visible.

In addition, in the display device 10 according to the embodiment, the LED 112 is disposed at the side of the scattering layer 105, and thus the entire device can be thinned as compared with a configuration of the related art in which the light source is disposed on the back side of the display panel 100.

In the display device 10 according to the embodiment, the scattering layer 105 is formed of a transparent material containing scattering fine particles.

Thus, the display device 10 according to the embodiment can increase the transparency of the scattering layer 105 without causing the scattering layer 105 to be clouded, and can increase the light scattering properties of the scattering layer 105. Therefore, the display device 10 according to the embodiment can make the outline of the light transmitting region 103A less visible when the LED 112 is turned off, and can increase the luminance of the optical image displayed on the display panel 100 when the LED 112 is turned on.

In the display device 10 according to the embodiment, the second decorative layer 106 has a decorative pattern having a brightness different from that of the first decorative layer 103.

Thus, in the display device 10 according to the embodiment, when the display panel 100 is viewed from its surface side with the LED 112 being turned off, the first decorative layer 103 and the second decorative layer 106 can have substantially the same apparent brightness, and thus the outline of the light transmitting region 103A provided in the first decorative layer 103 can be made inconspicuous.

In the display device 10 according to the embodiment, both the first decorative layer 103 and the second decorative layer 106 may represent a black-based decorative pattern.

Thus, the display device 10 according to the embodiment can make the outline of the light transmitting region 103A provided in the first decorative layer 103 inconspicuous when the display panel 100 is viewed from its surface side with the LED 112 being turning off.

In the display device 10 according to the embodiment, the scattering layer 105 may have a reflective finish for reflecting light on a surface orthogonal to and/or a surface opposite to the incident surface of light emitted from the LED 112. Examples of the reflective finish include white coating, a white tape, and a mirror finish. Thus, the display device 10 according to the embodiment can prevent leakage of light from the surface orthogonal to and/or the surface opposite to the incident surface of the scattering layer 105 when the LED 112 is turned on, and thus can increase the luminance of the optical image displayed on the display panel 100.

In the display device 10 according to the embodiment, the scattering layer 105 may have an absorption finish for absorbing light on the surface orthogonal to and/or the surface opposite to the incident surface of light emitted from the LED 112. Examples of the absorption finish include black coating and a black tape, and the like.

Thus, the display device 10 according to the embodiment can prevent leakage of light from the surface orthogonal to and/or the surface opposite to the incident surface of the scattering layer 105 when the LED 112 is turned on. Therefore, for example, in a case where a similar display device is placed adjacent to the display device 10, the display device 10 according to the embodiment can prevent the light incident on the scattering layer 105 from leaking to the adjacent display device from the surface orthogonal to and/or the surface opposite to the incident surface of the scattering layer 105.

### Modifications

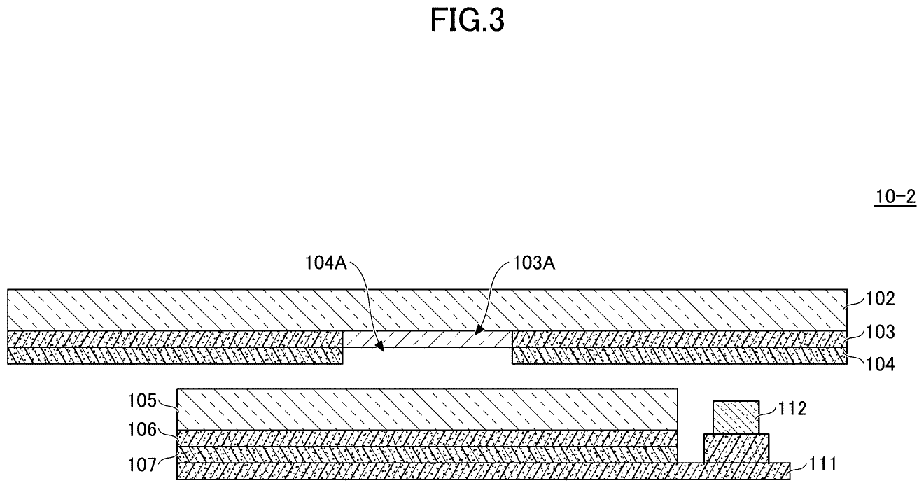

FIG. 3 is a view schematically illustrating a laminated structure of a display device 10-2 according to a modification of the embodiment.

As illustrated in FIG. 3, the display device 10-2 is different from the display device 10 in that the substrate 111 extends to a position overlapping the light transmitting region 103A, and the second decorative layer 106 and the second color-tone adjusting layer 107 are formed on the substrate 111 while the display device 10-2 is similar to the display device 10 in other respects.

The display device 10-2 having the configuration illustrated in FIG. 3 can achieve the same effect as the display device 10 illustrated in FIGS. 1 and 2.

In the display device 10-2, the surface of the substrate 111 on which the second decorative layer 106 and the second color-tone adjusting layer 107 are formed may be further covered with a transparent or translucent overcoat material.

In the display device 10 or 10-2, the first decorative layer 103 and the second decorative layer 106 may be formed by the same manufacturing method or different manufacturing methods.

In the display device 10 or 10-2, when the decorative pattern of the first decorative layer 103 and the decorative pattern of the second decorative layer 106 have a pattern (e.g., a lattice pattern), the pattern of the decorative pattern of the second decorative layer 106 may be larger than the pattern of the decorative pattern of the first decorative layer 103 in consideration of the perspective difference when the display panel 100 is viewed from its surface side.

Thus, when the display panel 100 is viewed from the surface side of the display device 10 or 10-2 with the LED 112 turned off, the size of the decorative pattern of the second decorative layer 106 and the size of the decorative pattern of the first decorative layer 103 can be made substantially equal in appearance, and the outline of the light transmitting region 103A provided in the first decorative layer 103 can be made inconspicuous.

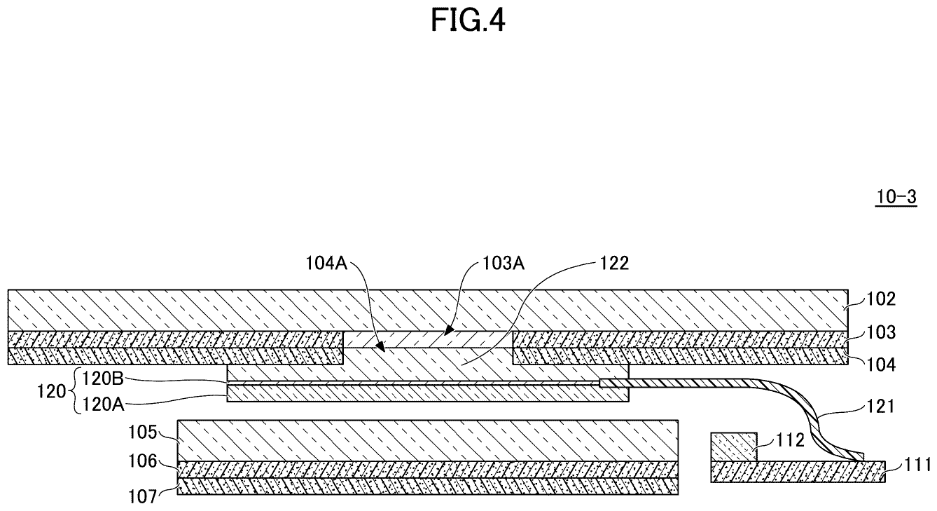

FIG. 4 is a view schematically illustrating a laminated structure of a display device 10-3 according to a modification of the embodiment. The display device 10-3 illustrated in FIG. 4 is different from the display device 10 in that an electrostatic sensor 120, an adhesive layer 122, and an FPC 121 are further provided while the display device 10-3 is the same as the display device 10 in other respects.

The electrostatic sensor 120 is disposed between the first color-tone adjusting layer 104 and the scattering layer 105. The electrostatic sensor 120 is formed of a base material 120A that is made of glass, polyethylene terephthalate (PET), or the like, and a sensor electrode 120B that is formed on the base material 120A, is made of indium tin oxide (ITO) or the like, and functions as an electrostatic sensor electrode.

The adhesive layer 122 is made of an optical clear adhesive (OCA), an optical clear resin (OCR), or the like, and fixes a surface of the sensor electrode 120B of the electrostatic sensor 120 to the lower surface of the base layer 102 on which the first decorative layer 103 and the first color-tone adjusting layer 104 are provided.

The base material 120A, the sensor electrode 120B, and the adhesive layer 122 are formed to be transparent, and do not substantially interfere with the light transmitted through the light transmitting region 104A.

The sensor electrode 120B is connected to the FPC 121, the sensor electrode 120B is driven, and a detection signal is output.

The electrostatic sensor 120 can detect a contact position of an operating body (e.g., a finger of an operator) with respect to a surface of the display device 10-3. Thus, the display device 10-3 can receive an operation input corresponding to a contact position by the operating body.

Although the embodiment and the modifications of the present disclosure have been described in detail, the present disclosure is not limited to these embodiment and modifications, and various substitutions or alterations can be made within the scope of the gist of the present disclosure described in the claims.

What is claimed is:

1. A display device comprising:
a first decorative layer representing a decorative pattern;
a light transmitting region provided in the first decorative layer, the light transmitting region being configured to transmit light;
a scattering layer disposed below the first decorative layer, the scattering layer being configured to scatter the light;
a light source disposed at a side of the scattering layer, the light source being configured to emit light toward the scattering layer; and
a second decorative layer disposed below the scattering layer and at a position overlapping the light transmitting region, the second decorative layer representing the decorative pattern.

2. The display device according to claim 1, wherein the scattering layer is formed of a transparent material, the transparent material containing scattering fine particles with light scattering properties.

3. The display device according to claim 1, wherein the second decorative layer has the decorative pattern having a brightness different from that of the first decorative layer.

4. The display device according to claim 1, wherein both the first decorative layer and the second decorative layer represent a black-based decorative pattern.

5. The display device according to claim 1, wherein a pattern of the decorative pattern of the second decorative layer is larger than a pattern of the decorative pattern of the first decorative layer.

6. The display device according to claim 1, wherein the scattering layer has a reflective finish for reflecting the light on a surface orthogonal to and/or a surface opposite to an incident surface of the light emitted from the light source.

7. The display device according to claim 1, wherein the scattering layer has an absorption finish for absorbing the light on a surface orthogonal to and/or a surface opposite to the incident surface of the light emitted from the light source.
